(19) United States
(12) Patent Application Publication
(10) Pub. No.: US 2024/0422061 A1
(43) Pub. Date: Dec. 19, 2024

(54) DISTRIBUTED LOCAL GROUP CONFIGURATION DATA STORAGE FOR IMPROVED GROUP EXTENSIBILITY

(71) Applicant: SHURE ACQUISITION HOLDINGS, INC., Niles, IL (US)

(72) Inventors: Ilya Trager, Niles, IL (US); Brendan Fox, Niles, IL (US)

(21) Appl. No.: 18/743,937

(22) Filed: Jun. 14, 2024

Related U.S. Application Data
(60) Provisional application No. 63/508,690, filed on Jun. 16, 2023.

(51) Int. Cl. H04L 41/0873; H04L 41/0803; H04L 41/22

(52) U.S. Cl. CPC H04L 41/0873; H04L 41/0803; H04L 41/22

(57) ABSTRACT

Various embodiments of the present disclosure provide methods, apparatus, systems, devices, and/or the like for improved group extensibility through distributed local group configuration data storage. An example method includes receiving, from one or more devices located within a network proximity, shared group configuration data, and, responsive to determining that a device conflict exists associated with the shared group configuration data, selecting as current shared group configuration data received shared group configuration data associated with a most recent update timestamp; and transmitting the current shared group configuration data to each device located within the network proximity.

### CROSS-REFERENCE TO RELATED APPLICATIONS

The present application claims priority to U.S. Provisional Application Ser. No. 63/508,690, titled “DISTRIBUTED LOCAL GROUP CONFIGURATION DATA STORAGE FOR IMPROVED GROUP EXTENSIBILITY,” filed Jun. 16, 2023, the entire contents of which are incorporated herein by reference.

### BACKGROUND

Applicant has identified many deficiencies and problems associated with existing methods, apparatus, and systems related to managing changes in networked device group membership. Through applied effort, ingenuity, and innovation, many of these identified deficiencies and problems have been solved by developing solutions that are configured in accordance with embodiments of the present disclosure, many examples of which are described in detail herein.

### BRIEF SUMMARY

In general, embodiments of the present disclosure provide methods, apparatus, systems, devices, and/or the like for improved group extensibility through distributed local group configuration data storage.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure. It will be appreciated that the scope of the disclosure encompasses many potential embodiments in addition to those here summarized, some of which will be further described below and embodied by the claims appended herein.

### BRIEF DESCRIPTION OF THE DRAWINGS

Having thus described some embodiments in general terms, references will now be made to the accompanying drawings, which are not necessarily drawn to scale, and wherein:

FIG. 1 is an example system architecture within which embodiments of the present disclosure may operate.

FIG. 2 depicts a schematic illustration of an example apparatus configured in accordance with one embodiment of the present disclosure.

FIG. 3A depicts example operations for use in accordance with embodiments of the present disclosure.

FIG. 3B depicts example operations for use in accordance with embodiments of the present disclosure.

FIGS. 4, 5, 6, 7, 8, 9, 10, 11, 12, and 13 depict operational examples of communication flow between a controller apparatus and devices, in accordance with embodiments of the present disclosure.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may embody in many different forms and should not be construed as limited to the embodiments set forth herein. Rather, these embodiments are provided so that this disclosure will satisfy applicable legal requirements.

### Overview

The present disclosure addresses technical problems associated with dynamically, accurately, efficiently and/or reliably using group configuration information or data distributed on networked devices in a given installation for the purposes of visualizing a device composition, design, or configuration of a physical enclosure (e.g., a room), audio routing, and acoustic coverage of devices. The present disclosure eliminates a need for an original configuration or design file (e.g., group design data structure) associated with a physical enclosure and provides for easy collaborative multi-user room maintenance and troubleshooting. The shared, distributed group configuration information or data provides for the re-creation (e.g., sometimes partial) of an original device group design or configuration (e.g., a configuration of devices positioned within a physical enclosure), detection of missing devices, and resolution of data integrity issues.

Moreover, embodiments herein further overcome drawbacks and technical problems associated with a requirement of network connectivity in order to design and deploy a logical grouping of devices. While existing systems may solely rely upon cloud storage for storage and retrieval of group configuration information in order to support group extensibility and/or resolve device conflicts, such systems suffer drawbacks associated with a requirement for network connectivity. In environments where network connectivity is unavailable or unreliable, a system solely relying upon cloud-based group configuration information will not be able to support deployments of or changes in group configuration in real-time, while the changes and information remain meaningful. Embodiments herein overcome such drawbacks by utilizing locally stored group configuration information.

In some examples, a logical grouping of devices can be created using a remote computing device while the remote computing device is physically separated from the intended logical grouping of devices (e.g., the remote computing device is used to generate the logical grouping while it is located on an airplane without network connectivity); the logical grouping of devices can then be deployed when the remote computing device regains connectivity and remains separate from the devices. In another example, the logical grouping of devices can subsequently be deployed when the remote computing device is physically within a given proximity of the intended logical grouping of devices (e.g., within a close enough distance to communicate using a shorter-distance communication protocol or a local network). Accordingly, a logical grouping of devices can be created, deployed, updated, and/or mapped to a physical enclosure virtually or in offline use cases.

In some examples, after an initial deployment of a device group design or configuration (e.g., a group configuration data structure) including multiple devices optionally mapped to a physical enclosure, each device in the device group design or configuration contains the same shared group configuration data that describes device identifiers and device types in the device group design or configuration. The distributed shared group configuration data supplements individual settings and data also stored on each device.

In scenarios where an original creator of a group configuration data structure is no longer available (e.g., a user having an account with an application for generating a group configuration data structure, where the user is the owner of such a data structure, may no longer be employed with a company, etc.), it is often difficult or impossible for a subsequent user to access the group configuration data without having to start from scratch (e.g., creating a new group configuration data structure, and reconfiguring all of the devices to be associated with the new group configuration data structure. Embodiments herein overcome such drawbacks by enabling any computing device (e.g., a new observer of the group) to discover the group without having to be the computing device associated with designing the group. That is, any computing device may approach a logical grouping of devices and discover the group by way of retrieving the shared group configuration data stored thereon.

Examples herein further provide for visualization of a system configuration including an audio block diagram and acoustic coverage (or other features) without access to an original design or configuration file (e.g., group design data structure). That is, a device group design or configuration (e.g., optionally mapped to a physical enclosure) can be reconstructed (e.g., sometimes partially) by using the distributed shared group configuration data stored on the devices associated with the group design data structure. Moreover, the device group design or configuration can be reconstructed (e.g., sometimes partially) by using a subset of the distributed shared group configuration data stored on the devices associated with the group design data structure, in the event that one or more of the devices is not available or online.

### Example System Architecture and Apparatus for Implementing Embodiments of the Present Disclosure

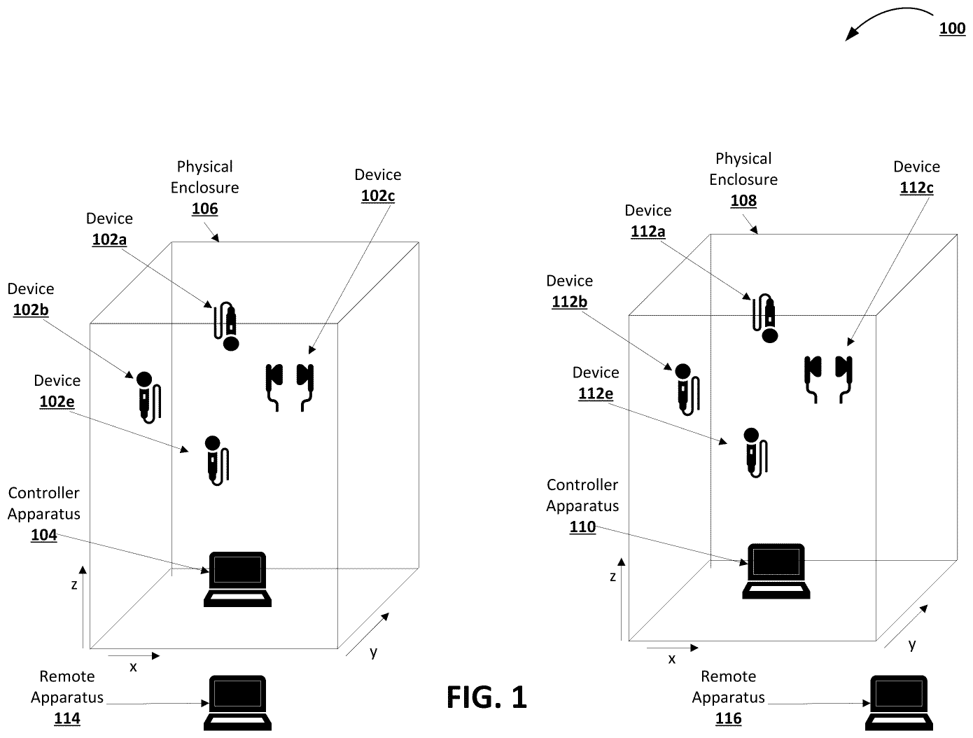

FIG. 1 is an example architecture 100 for performing various distributed device group configuration data storage operations of the present disclosure. In the example embodiment of FIG. 1, a first physical enclosure 106 may have situated therein a controller apparatus 104 configured to generate a group configuration having multiple devices (e.g., devices 102a-102e) associated therewith. The example architecture may also include a second physical enclosure 108 (e.g., a room or area separate from the first physical enclosure 106) may have situated therein a controller apparatus 110 configured to generate a group configuration having multiple devices (e.g., devices 112a-112e) associated therewith. It will be appreciated that controller apparatuses 104, 110 may be initially present within their respective physical enclosures but may not permanently be present therein. It will further be appreciated that controller apparatuses 104, 110 may not be present within their respective physical enclosures at a time of generation of a group configuration data structure.

It will be appreciated that, while FIG. 1 depicts a first physical enclosure 106 having associated therewith a group configuration having multiple devices (e.g., 102a-102e), and a second physical enclosure 108 having associated therewith a group configuration having multiple devices (e.g., 112a-112e), a group configuration data structure is not necessarily mapped to a physical enclosure in all embodiments herein. That is, a group configuration data structure may define a logical grouping of devices and may be referred to herein as a “design” or a “room” without being mapped to (e.g., or tied to or associated with) a physical enclosure. A group configuration data structure (e.g., a room, in embodiments herein) is optionally mapped to a physical enclosure, in some embodiments.

Controller apparatus 104 may be configured to communicate with remote apparatus 114, which may be situated within or near the first physical enclosure 106 or remote from the first physical enclosure 106. Controller apparatus 110 may be configured to communicate with remote apparatus 116, which may be situated within or near the first physical enclosure 106 or remote from the second physical enclosure 108. Each of controller apparatus 104 and 110 may be configured to receive commands or requests from remote apparatus 114 and 116, respectively, and transmit responses to the remote apparatuses 114 and 116, respectively. In some examples, the controller apparatuses 104 and 110 may interact with remote apparatuses 114 and 116 via an application programming interface (API) or other communication interface via one or more communications networks.

In some examples, multiple controller apparatuses and multiple remote apparatuses may be associated with a physical enclosure.

It will be appreciated that devices 102a-102e and 112a-112e can be any of audio capture devices, audio output devices, computing devices, mobile computing devices, video capture devices, video output devices, infrared capture devices, radar devices, light detecting and ranging (LiDAR) devices, sensor devices, output devices, other capture devices for audio and/or video, and/or the like without departing from the scope of the present disclosure. It will also be appreciated that any of devices 102a-102e may be physically removed from (e.g., and subsequently returned to) first physical enclosure 106, and any of devices 112a-112e may be physically removed from (e.g., and subsequently returned to) second physical enclosure 108.

A group configuration data structure or design file (not shown), generated using controller apparatus 104, may be associated with the first physical enclosure 106. A group configuration data structure is one or more items of data arranged according to a data structure (e.g., a file) that represents a grouping and/or specific configuration of devices (e.g., optionally mapped to and positioned relative to a physical enclosure). The group configuration data structure may include data associated with each of the devices 102a-102e (e.g., and optionally their locations within the first physical enclosure 106 relative to one another and/or aspects or features of or within the first physical enclosure 106 if the group configuration data structure is mapped to the first physical enclosure 106). Similarly, a group configuration data structure or design file (not shown), generated using controller apparatus 110, may optionally be associated with the second physical enclosure 108. The group configuration data structure may include data (e.g., device identifiers) associated with each of the devices 112a-112e (e.g., and optionally their locations within the second physical enclosure 108 relative to one another and/or aspects or features of or within the second physical enclosure 108 if the group configuration data structure is mapped to the second physical enclosure 108).

The locations of devices 102a-102e and 112a-112e may be indicated using a set of coordinates (e.g., x, y, z), which may specify a location relative to a distinct location, such as a location relative to a corner, center, object, or other capture device of the first or second physical enclosures, respectively. In some examples, the group configuration data structure may further include data associated with the physical enclosure (e.g., a physical enclosure identifier, dimensions of the physical enclosure, acoustic or other features associated with the physical enclosure, metadata associated with the physical enclosure, audio routing and acoustic coverage of audio capture devices (e.g., microphones) and audio output devices (e.g., loud speakers), and/or the like).

Controller apparatus 104 and 110 (and/or remote apparatuses 114 and 116), and any of devices 102a-102e and 112a-112e may be configured to operate with one or more computer program applications, plug-ins, and/or the like. For example, controller apparatus 104 and 110 (and/or remote apparatuses 114 and 116) may be configured to execute a device design or configuration computer program application. The device design or configuration computer program application may be configured to generate a group configuration data structure or design file associated with a physical enclosure.

Controller apparatus 104 and 110 may further be configured to communicate with any of devices 102a-102e and 112a-112e, respectively.

In order to support functionality described herein, in some examples, devices 102a-102e and 112a-112e may be additionally configured with microcontrollers (e.g., processing capabilities), communication circuitry (e.g., for communicating with controller apparatus 104, 110), memory (e.g., for storing shared group configuration data and individual settings), and/or the like.

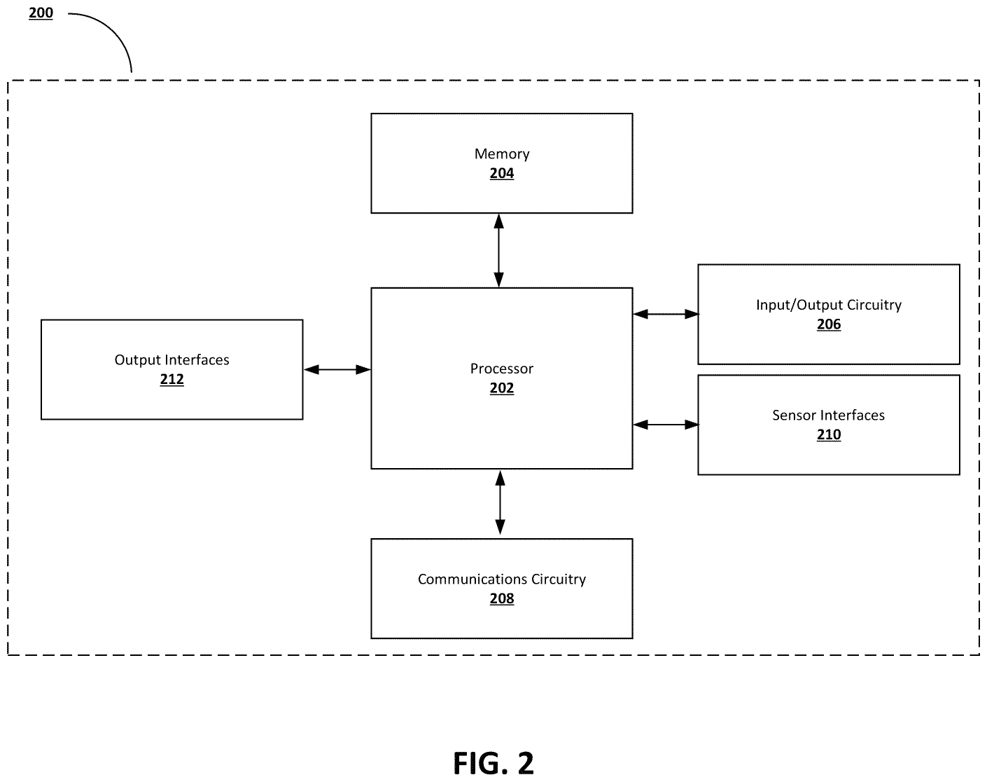

An example architecture for controller apparatuses 104 and 110, as well as remote apparatuses 114 and 116, is depicted in the apparatus 200 of FIG. 2. As depicted in FIG. 2, the apparatus 200 includes processor 202, memory 204, input/output circuitry 206, communications circuitry 208, sensor interfaces 210, and output interfaces 212. Although these components 202-212 are described with respect to functional limitations, it should be understood that the particular implementations necessarily include the use of particular hardware. It should also be understood that certain of these components 202-212 may include similar or common hardware. For example, two sets of circuitries may both leverage use of the same processor, network interface, storage medium, or the like to perform their associated functions, such that duplicate hardware is not required for each set of circuitries.

The processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

The processor 202 may be a central processing unit (CPU), a microprocessor, a coprocessor, a digital signal processor (DSP), an Advanced RISC Machine (ARM), a field programmable gate array (FPGA), a controller, or a processing element. The processor 202 may also be embodied in various other processing circuitry including integrated circuits such as, for example, a microcontroller unit (MCU), an ASIC (application specific integrated circuit), a hardware accelerator, or a special-purpose electronic chip. Furthermore, the processor 202 may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

The processor 202 may be configured to execute instructions stored in the memory 204 or otherwise accessible to the processor 202. The processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The apparatus 200 may include input/output circuitry 206 that may, in turn, be in communication with processor 202 to provide output to the user and may receive an indication of a user input. The input/output circuitry 206 may comprise a user interface and may include a display, and may comprise a web user interface, a mobile application, a client device, a kiosk, or the like. The input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network.

The sensor interfaces 210 may be configured to receive signals from the devices 102a-102e or 112a-112e. The output interfaces 212 may be configured to provide signals to the devices 102a-102e or 112a-112c.

In some embodiments, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 200. One or more external systems (such as a remote cloud computing and/or data storage system) may also be leveraged to provide at least some of the functionality discussed herein.

With respect to components of the apparatus 200, the term “circuitry” as used herein and defined above should therefore be understood to include particular hardware configured to perform the functions associated with the particular circuitry as described herein. For example, in one embodiment, “circuitry” may include processing circuitry, storage media, network interfaces, input/output devices, and the like. In one embodiment, other elements of the apparatus 200 may provide or supplement the functionality of particular circuitry. For example, the processor 202 may provide processing functionality, the memory 204 may provide storage functionality, the communications circuitry 208 may provide network interface functionality, and the like. Similarly, other elements of the apparatus 200 may provide or supplement the functionality of particular circuitry.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Data Flows of Embodiments of the Present Disclosure

Embodiments of the present disclosure provide for a controller apparatus that is configured to transmit, receive, and/or read shared group configuration data to/from one or more devices that have been assigned to a logical grouping and/or positioned within or relative to a physical enclosure to which the logical grouping has been mapped, where the shared group configuration data is stored locally on each of the devices. Embodiments herein then provide for either the controller apparatus (e.g., or other controller apparatuses), or another apparatus, to discover the devices associated with the group configuration data structure (e.g., optionally associated with the physical enclosure), as well as a composition or other features of the group configuration data structure based on the shared group configuration data (e.g., without access to the original group configuration data structure).

In some examples, shared group configuration data may include a name of a group (e.g., referred to herein as a “room” or “logical room” or “logical group” or “logical grouping”) and/or physical enclosure (e.g., when the group is mapped to a physical enclosure) as well as a group identifier. The group identifier may include one or more items of data by which a group or physical enclosure may be uniquely identified, including ASCII or text, and may be referred to as a group universal unique identifier (UUID). The shared group configuration data may further include a list of other members of the group, for example other devices that have been designated as part of the group or physical enclosure. In some examples, the other members of the group may be listed according to device identifier, which may be one or more items of data by which the device may be uniquely identified. The shared group configuration data may further include a timestamp associated with the time when the shared group configuration data was last updated with respect to a given device. It will be appreciated that the shared group configuration data is preferably identical across all current devices of a given group such that the devices agree with respect to membership (e.g., which devices are in the group) and common data (e.g., what is the group name and/or description).

In some examples, in addition to the shared group configuration data, each device of a group of devices (e.g., 102a-e, 112a-e) can store individual settings.

In some examples, when a controller apparatus deploys a group configuration data structure (e.g., a room design, whether new or updated) for a logical grouping (e.g., optionally mapped to a physical enclosure), a separate, remote, apparatus may further be configured to render a visual representation of the grouping (e.g., and/or physical enclosure according to the group configuration data structure without being in possession of the group configuration data structure. That is, the controller apparatus can cause the rendering, via a display device, of the formation of the group configuration data structure in real time without any transfer of the group configuration data structure from the controller apparatus to the separate or remote apparatus. The separate or remote apparatus may also be able to observe when the devices associated with a physical enclosure are disassociated from the physical enclosure.

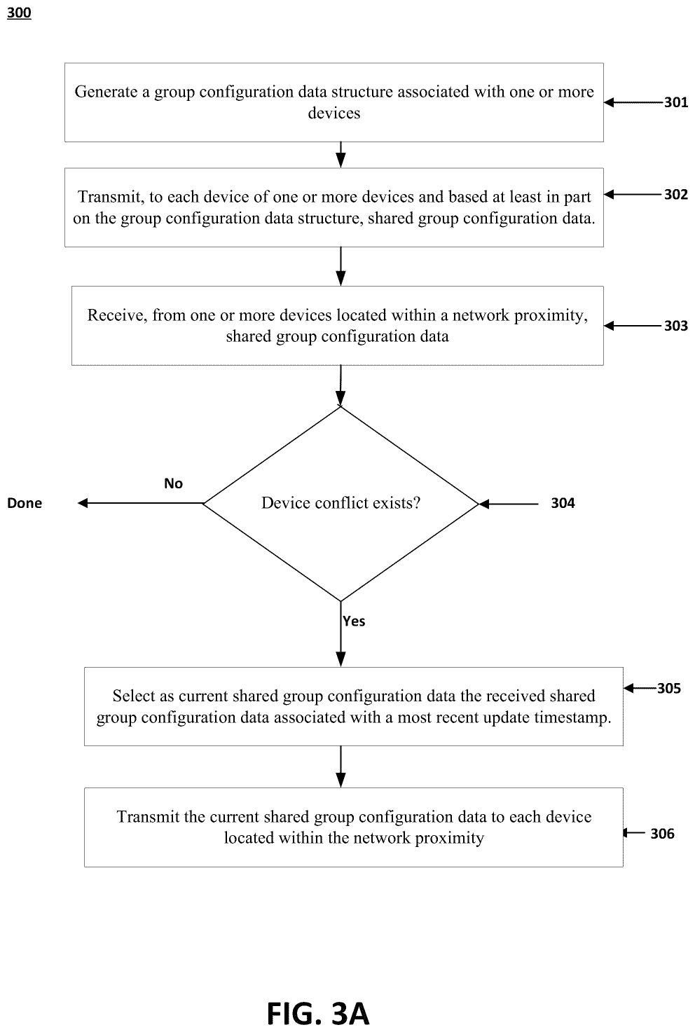

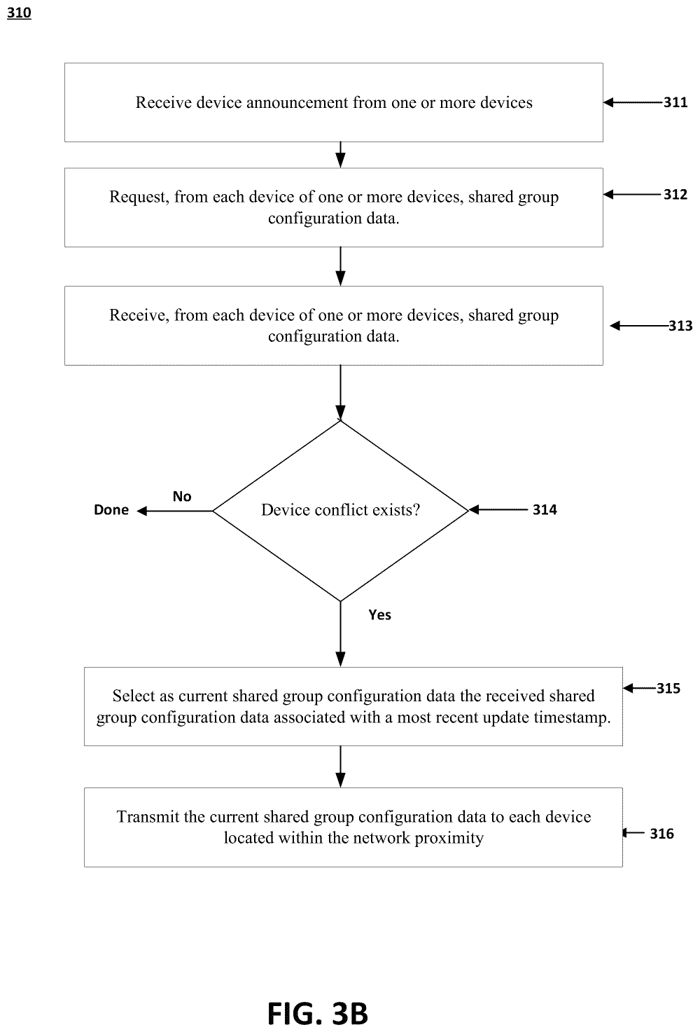

FIG. 3A depicts example operations for performance in accordance with embodiments of the present disclosure. Example process 300 may be carried out by a controller apparatus, such as apparatus 104 or apparatus 110 (an example of which is shown as apparatus 200 in FIG. 2).

The example process 300 begins at operation 301, when a controller apparatus (e.g., apparatus 200 of FIG. 2) generates a group configuration data structure associated with one or more devices. The group configuration data structure may include a group configuration identifier and one or more device identifiers each associated with the one or more devices.

In some examples, the controller apparatus (e.g., apparatus 200 of FIG. 2) may map the group configuration data structure to a physical enclosure such that the one or more devices are positioned in relation to the physical enclosure. In such examples, the group configuration data structure may further include one or more of device coordinates associated with each device identifier, a physical enclosure identifier, physical dimensions associated with the physical enclosure, acoustic or other features associated with the physical enclosure, or metadata associated with the physical enclosure.

The example process 300 may continue at operation 302, when the controller apparatus (e.g., apparatus 200) transmits, to each device of the one or more devices and based on the group configuration data structure, shared group configuration data. In some examples, the shared group configuration data includes the group configuration identifier and the one or more device identifiers. In some examples, the shared group configuration data may further include group configuration metadata (e.g., installation notes, schematic layout, coverage layout, additional information about the group or optionally mapped physical enclosure). In some examples, the shared group configuration data includes a timestamp associated with the most recent time it has been updated with respect to a given group or device.

The example process may continue at operation 303, when the controller apparatus (e.g., apparatus 200) receives shared group configuration data from one or more devices within a network proximity.

The example process may continue at operation 304, when the controller apparatus (e.g., apparatus 200) determines whether a device conflict exists associated with the group of devices. In some examples, determining whether a device conflict exists is based on a review or comparison of the received shared group configuration data from the one or more devices within the network proximity. In some examples, the controller apparatus may determine whether a device conflict exists based on receiving shared group configuration data from a first device that does not entirely match or agree with shared group configuration data from one or more other devices. That is, the shared group configuration data from the first device may have membership data (e.g., which devices are in the group) and common data (e.g., what is the group name and/or description), either or both of which may differ from shared group configuration data received from one or more other devices. When the membership data differs, a membership conflict exists; when the common data differs, a common data conflict exists.

The example process 300 may continue when the controller apparatus (e.g., apparatus 200), at operation 305, responsive to determining that a device conflict exists associated with the group of devices, selects as the current shared group configuration data based on received shared group configuration data that is associated with a most recent update timestamp relative to other received shared group configuration data. That is, of all of the shared group configuration data received from one or more of the devices, the controller apparatus considers shared group configuration data associated with the latest or most recent timestamp to be ground truth and uses that shared group configuration data to resolve the conflict.

In some examples, selecting the current shared group configuration data may result in the addition of a device identifier to the shared group configuration data, or the removal of a device identifier from the shared group configuration data.

The example process 300 may continue when the controller apparatus (e.g., apparatus 200), at operation 306, transmits the current shared group configuration data to each device located within the network proximity (e.g., same multicast domain; same IP address; etc.). The devices may then be configured to store or replace stored shared group configuration data with the current shared group configuration data (e.g., along with a timestamp associated with the current shared group configuration data).

In some examples, the controller apparatus (e.g., apparatus 200) may further be configured to generate a user interface configured to render display of at least a portion of the group based on the current shared group configuration data and cause display of the user interface via a display device. In some examples, causing the display of the user interface may be completed via a remote computing apparatus.

FIG. 3B depicts example operations for performance in accordance with embodiments of the present disclosure. Example process 310 may be carried out by a controller apparatus, such as apparatus 104 or apparatus 110 (an example of which is shown as apparatus 200 in FIG. 2).

The example process 310 begins at operation 311, when a controller apparatus (e.g., apparatus 200 of FIG. 2) receives a device announcement from one or more devices, where the device announcement includes a device identifier (e.g., and optionally a device type) associated with each device of the one or more devices.

For example, when the controller apparatus and devices are operating according to a multicast protocol, a device may broadcast or announce its presence by broadcasting its device identifier and device type. In some examples, the controller apparatus and the devices may be operating according to a unicast protocol. In such an example, the controller apparatus polls devices according to an IP address in order to obtain device identifiers and device types.

The example process 310 continues at operation 312, when the controller apparatus (e.g., apparatus 200 of FIG. 2) requests shared group configuration data from each device of the one or more devices.

The example process 310 continues at operation 313, when the controller apparatus (e.g., apparatus 200 of FIG. 2) receives shared group configuration data from each device of the one or more devices. The shared group configuration data from each device may include membership data (e.g., a list of device identifiers associated with the group, common data (e.g., a group UUID associated with the group, optionally a name associated with the group, optionally a description of the group, optionally details regarding a physical enclosure to which the group is mapped), and a timestamp associated with when the shared group configuration data was updated or created.

The example process 310 continues at operation 314, when the controller apparatus (e.g., apparatus 200 of FIG. 2) determines whether a device conflict exists associated with the group of devices. In some examples, the controller apparatus may determine whether a device conflict exists based on receiving shared group configuration data from a first device that does not entirely match or agree with shared group configuration data from one or more other devices. That is, the shared group configuration data from the first device may have membership data (e.g., which devices are in the group) and common data (e.g., what is the group name and/or description), either or both of which may differ from shared group configuration data received from one or more other devices. When the membership data differs, a membership conflict exists; when the common data differs, a common data conflict exists. If no conflict exists, the process 310 ends.

The example process 310 may continue when the controller apparatus (e.g., apparatus 200), at operation 315, resolves the conflict. Resolving the conflict, in some examples, includes selecting as current shared group configuration data the received shared group configuration data associated with a most recent update timestamp relative to the other received shared group configuration data. That is, of all of the shared group configuration data received from one or more of the devices, the controller apparatus considers shared group configuration data associated with the latest or most recent timestamp to be ground truth and uses that shared group configuration data to resolve the conflict.

The example process 300 may continue when the controller apparatus (e.g., apparatus 200), at operation 316, transmits the current shared group configuration data to each device located within the network proximity (e.g., same multicast domain; same IP address; etc.). The devices may then be configured to store or replace stored shared group configuration data with the updated shared group configuration data (e.g., along with a timestamp associated with the updated shared group configuration data).

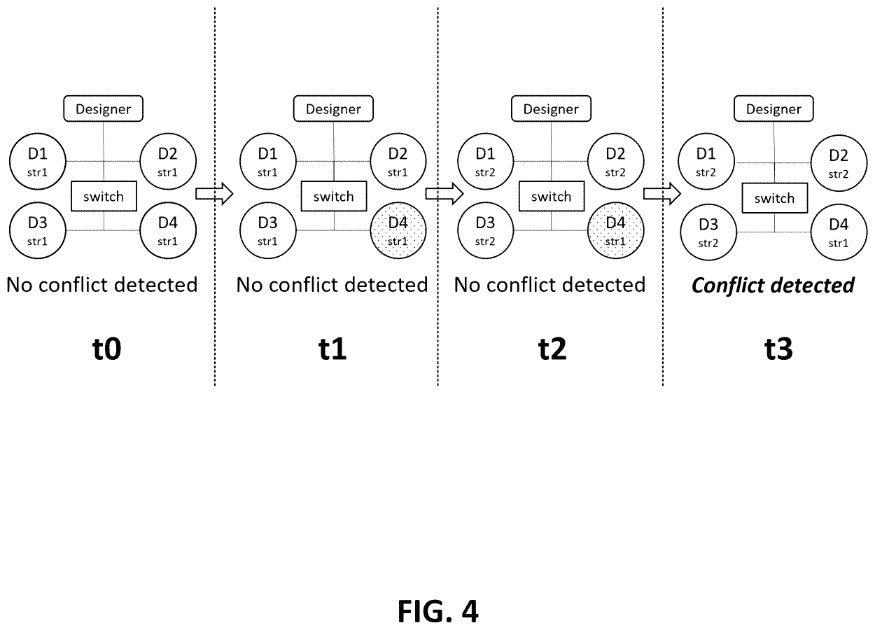

FIGS. 4-13 depict several operational examples of communication flow between a controller apparatus (e.g., 104, 110) and devices (e.g., 102a-e, 112a-e), in accordance with embodiments of the present disclosure. In some of the FIGS., multiple compute entities (CE1, CE2, CE1A, CE1B, CE2A, CE2B) interact with one another as part of a device management process, and the compute entities may be collocated as a part of controller apparatus or may be separate from one another (e.g., on premises, remote, deployed from the cloud, as part of an application installed on the controller apparatus, etc.).

FIG. 4 depicts an operational example of a shared group configuration data inconsistency (e.g., device conflict associated with a physical enclosure), in accordance with embodiments herein. In FIG. 4, at time t0, a controller apparatus (e.g., “Designer” in FIG. 4) may have generated a group configuration data structure including devices D1, D2, D3, and D4, with a group name or identifier of “str1”. It is shown in FIG. 4 that each of the devices D1, D2, D3, and D4 has stored thereon the group name or identifier of “str1” at time t0—therefore no conflict is detected. Shown at time t1 in FIG. 4, device D4 is turned off or otherwise goes offline, and no conflict is detected. Shown at time t2 in FIG. 4, the shared group configuration data is updated with a new group name or identifier of “str2”, and each of the online devices D1, D2, D3 receive and store the new group name or identifier of “str2”—no conflict is detected. At time t3 in FIG. 4, device D4 comes back online and is storing (and communicates that) a group name of “str1,” which is out of date—a conflict is detected. In other words, no conflict exists at the time of group creation. Conflicts are detected after the group is created and is changed by any means in such a way that not all members received the change (e.g., in this example, D4 missed the update of the group name to str2).

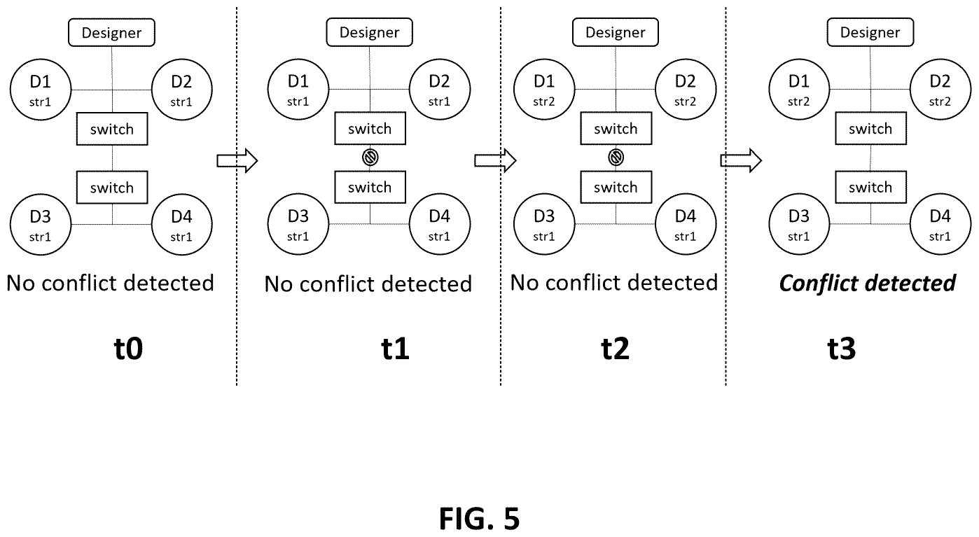

FIG. 5 depicts an operational example of a shared group configuration data inconsistency (e.g., device conflict associated with a physical enclosure), in accordance with embodiments herein. In FIG. 5, the shared group configuration data is updated while the network is divided by way of disconnecting two switches. In FIG. 5, at time t0, a controller apparatus (e.g., “Designer” in FIG. 5) may have generated a group configuration data structure including devices D1, D2, D3, and D4, with a group name or identifier of “str1”. It is shown in FIG. 5 that each of the devices D1, D2, D3, and D4 has stored thereon the group name or identifier of “str1” at time t0—therefore no conflict is detected. Shown at time t1 in FIG. 5, the network is divided (e.g., the two switches are disconnected), and no conflict is detected. Shown at time t2 in FIG. 5, the shared group configuration data is updated with a new group name or identifier of “str2”, and each of the online devices D1, and D2 receive and store the new group name or identifier of “str2”-no conflict is detected because the network continues to be divided. At time t3 in FIG. 5, the two networks are joined, therefore devices D3 and D4 come back online and are storing (and communicates that) a group name of “str1,” which is out of date—a conflict is detected.

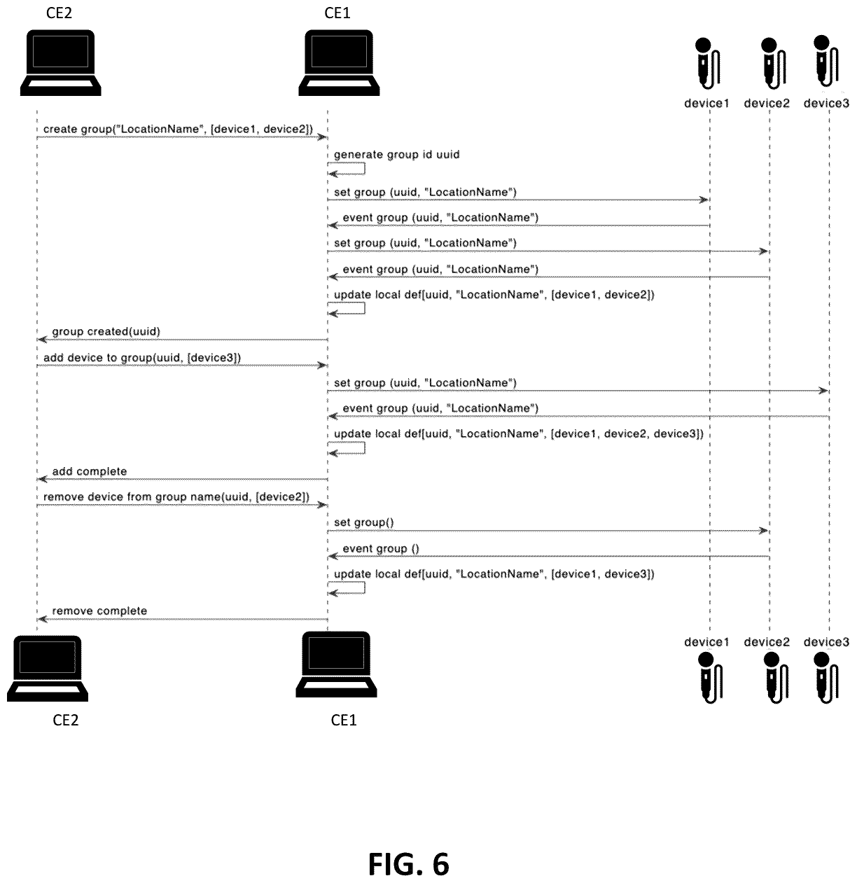

FIG. 6 depicts an operational example of creating or updating a shared group configuration data structure, in accordance with embodiments herein. In FIG. 6, a compute entity CE2 may request to another compute entity CE1 (e.g., which may be collocated with or separate from one another, in accordance with a controller apparatus such as apparatus 200) to create a group (e.g., a group configuration data structure). The compute entity CE1 may then be configured to generate a group UUID and a group name (“Location Name”) and transmit the same to device1 and device2 (e.g., devices 102a-102e or 112a-112e). The compute entity CE1 may also be configured to receive an echo of the data (e.g., the group UUID and “LocationName” as the group name) from each of device1 and device2. The compute entity CE1 may then communicate the group UUID and group name to the compute entity CE2. The compute entity CE2 may request to add another device to the group. The compute entity CE1 may then transmit the group UUID and group name to device3 and receive location information from device3. The compute entity CE1 may update the group configuration data structure to add device3.

In some examples, the compute entity CE2 may request to remove a device (e.g., device2) from the group UUID. The compute entity CE1 may then communicate to device2 that its group has changed, and then update the group configuration data structure to remove device3. When each of the changes has been made, the compute entity CE1 may communicate such to the compute entity CE2.

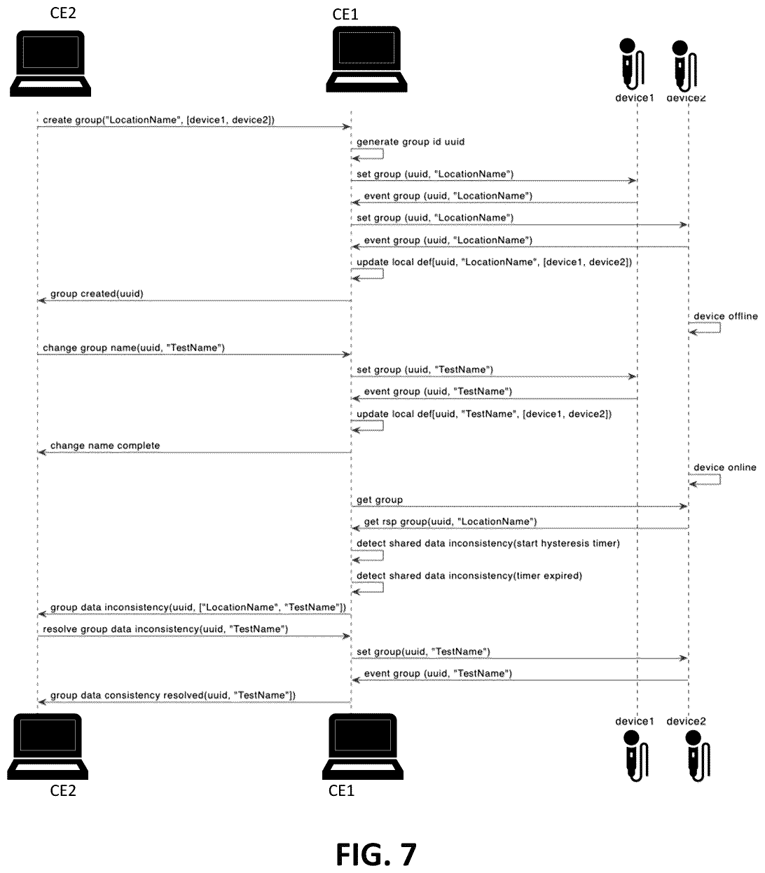

FIG. 7 depicts an operational example of user driven resolution of a shared data or device inconsistency, with two compute entities, in accordance with embodiments herein. In FIG. 7, a compute entity CE2 may request to another compute entity CE1 (e.g., which may be collocated with or separate from one another, in accordance with a controller apparatus such as apparatus 200) to create a group (e.g., a group configuration data structure). The compute entity CE1 may then be configured to generate a group UUID and group name (e.g., “LocationName”), and transmit the same to device1 and device2 (e.g., devices 102a-102e or 112a-112e). The compute entity CE1 may also be configured to receive an echo of the group UUID and group name from each of device1 and device2. The compute entity CE1 may then communicate the group UUID and the group name to the compute entity CE2.

Device2 may go offline for some reason before the compute entity CE2 requests to change the group name. In such an example, device2 is not in receipt of the updated group name when it comes back online. Subsequently, the compute entity CE1 detects an inconsistency (e.g., device conflict) because device2 has stored thereon the incorrect group name. The compute entity CE1, upon determining that device2 should still be a part of the group, and at the instruction of the compute entity CE2, may then resolve the inconsistency.

When each of the changes or resolutions has been made, the compute entity CE1 may communicate such to the compute entity CE2.

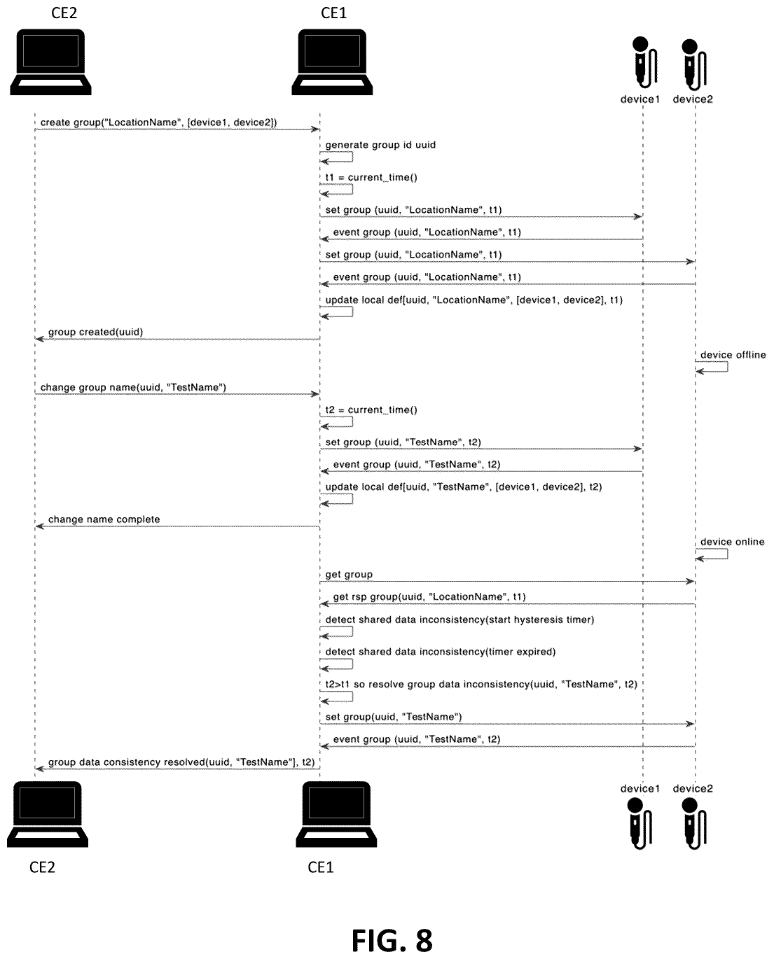

FIG. 8 depicts an operational example of automatic resolution of a shared data or device inconsistency, with two compute entities, in accordance with embodiments herein. In FIG. 8, a compute entity CE2 may request to another compute entity CE1 (e.g., which may be collocated with or separate from one another, in accordance with a controller apparatus such as apparatus 200) to create a group (e.g., a group configuration data structure). The compute entity CE1 may then be configured to generate a group UUID and a group name (e.g., “LocationName”), and transmit the same to device1 and device2 (e.g., devices 102a-102e or 112a-112e). The compute entity CE1 may also be configured to receive an echo of the group UUID and group name from each of device1 and device2. The compute entity CE1 may then communicate the group UUID and group name to the compute entity CE2.

Device2 may go offline for some reason before the compute entity CE2 requests to change the group name. In such an example, device2 is not in receipt of the updated group name when it comes back online. Subsequently, the compute entity CE1 detects an inconsistency (e.g., device conflict) because device2 has stored thereon the incorrect group name. The compute entity CE1, upon determining that device2 should still be a part of the group, and without involving the compute entity CE2, may then automatically resolve the inconsistency based on timestamps.

When each of the changes or resolutions has been made, the compute entity CE1 may communicate such to the compute entity CE2.

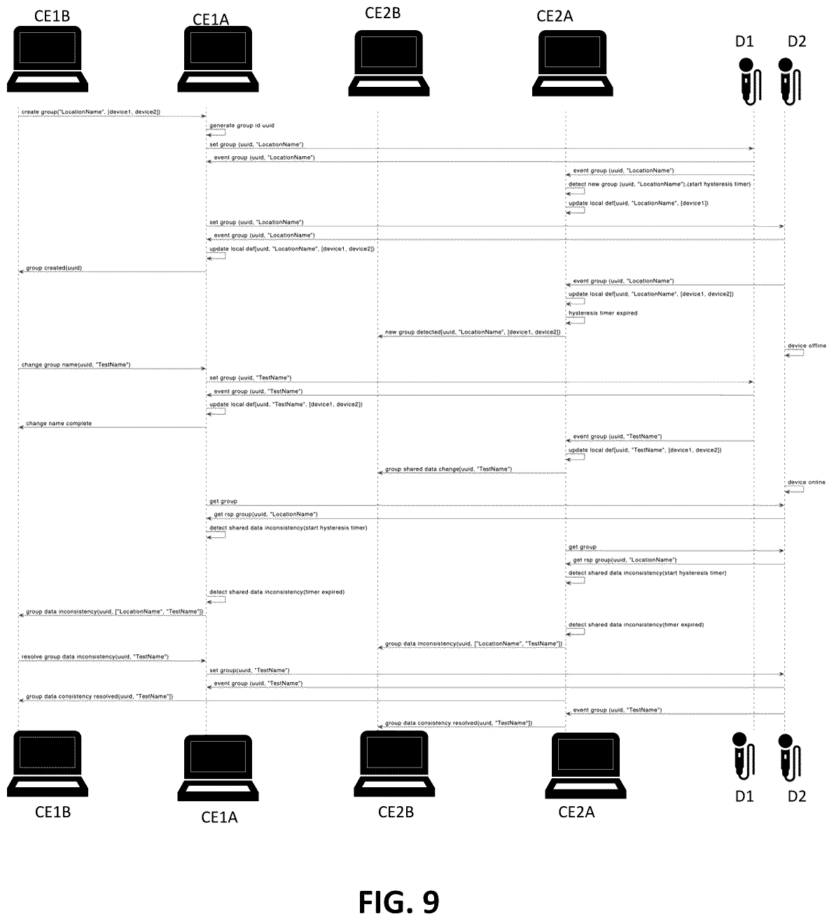

FIG. 9 depicts an operational example of user driven resolution of a shared data or device inconsistency, with multiple compute entities (CE1A, CE1B, CE2A, CE2B), in accordance with embodiments herein. In FIG. 9, a compute entity CE1B may request to another compute entity CE1A (e.g., which may be collocated with or separate from one another, in accordance with a controller apparatus such as apparatus 200) to create a group (e.g., a group configuration data structure). The compute entity CE1A may then be configured to generate a group UUID and a group name and transmit the same to device D1 and device D2 (e.g., devices 102a-102e or 112a-112e). The compute entity CE1A may also be configured to receive an echo of the group UUID and group name from each of device D1 and device D2. The compute entity CE1A may then communicate the group UUID and group name to the compute entity CE1B.

Device D2 may go offline for some reason before the compute entity CE1B requests to change the group name. In such an example, device D2 is not in receipt of the updated group name when it comes back online. Subsequently, the compute entity CE1A detects an inconsistency (e.g., device conflict) because device D2 has stored thereon the incorrect group name (e.g., the shared group configuration data received from device D2 includes a group name that differs from that in shared group configuration data of other devices). The compute entity CE1A, upon determining that device D2 should still be a part of the group, and at the instruction of the compute entity CE1B, may then resolve the inconsistency.

When each of the changes or resolutions has been made, the compute entity CE1A may communicate such to the compute entity CE1B. A compute entity CE2B and another compute entity CE2A (e.g., which may be collocated with or separate from one another, in accordance with a controller apparatus such as apparatus 200) may be updated based on receiving data from devices D1 and D2.

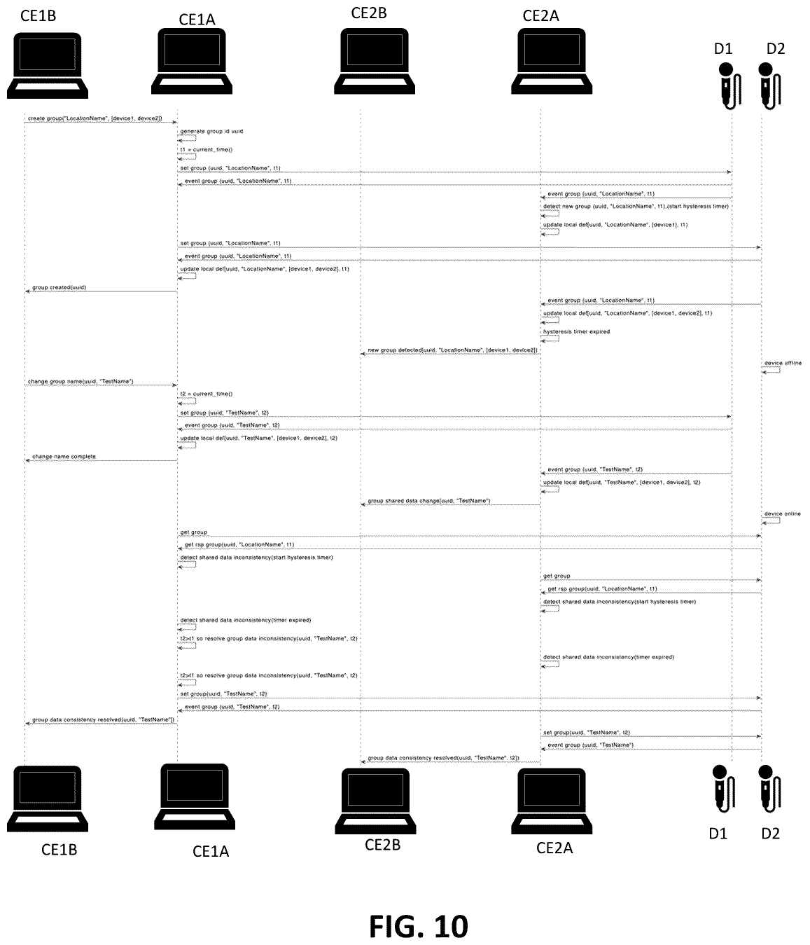

FIG. 10 depicts an operational example of automatic resolution of a shared data or device inconsistency, with multiple compute entities (CE1A, CE1B, CE2A, CE2B), in accordance with embodiments herein. In FIG. 10, a compute entity CE2 may request to another compute entity CE1 (e.g., which may be collocated with or separate from one another, in accordance with a controller apparatus such as apparatus 200) to create a group (e.g., a group configuration data structure). The compute entity CE1A may then be configured to generate a group UUID and a group name and transmit the same to device D1 and device D2 (e.g., devices 102a-102e or 112a-112e). The compute entity CE1A may also be configured to receive an echo of the group UUID and group name from each of device D1 and device D2. The compute entity CE1A may then communicate the group UUID and the group name to the compute entity CE1B.

Device D2 may go offline for some reason before the compute entity CE1B requests to change the group name. In such an example, device D2 is not in receipt of the updated group name when it comes back online. Subsequently, the compute entity CE1A detects an inconsistency (e.g., device conflict) because device2 has stored thereon the incorrect group name (e.g., or a group name that differs from that of another piece of shared group configuration data received). The compute entity CE1A, upon determining that device D2 should still be a part of the group, and without involving the compute entity CE1B, may then automatically resolve the inconsistency based on timestamps.

When each of the changes or resolutions has been made, the compute entity CE1A may communicate such to the compute entity CE1B. A compute entity CE2B and another compute entity CE2A (e.g., which may be collocated with or separate from one another, in accordance with a controller apparatus such as apparatus 200) may be updated based on receiving data from devices D1 and D2.

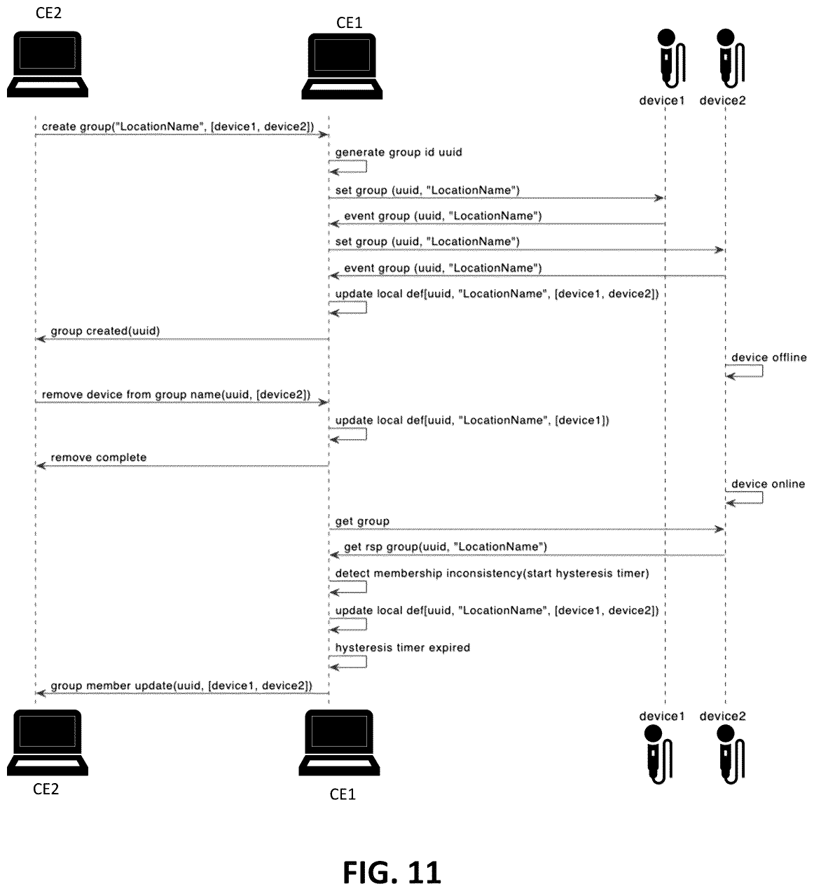

FIG. 11 depicts an operational example of resolution of device membership inconsistency, with two compute entities, in accordance with embodiments herein. In FIG. 11, a compute entity CE2 may request to another compute entity CE1 (e.g., which may be collocated with or separate from one another, in accordance with a controller apparatus such as apparatus 200) to create a group (e.g., a group configuration data structure). The compute entity CE1 may then be configured to generate a group UUID, and group name and transmit the same to device1 and device2 (e.g., devices 102a-102e or 112a-112e). The compute entity CE1 may also be configured to receive an echo of the group UUID and group name from each of device1 and device. The compute entity CE1 may then communicate the group UUID and group name to the compute entity CE2.

Device2 may go offline for some reason before the compute entity CE2 requests to remove device2 from the group. In such an example, device2 is not in receipt of the updated group when it comes back online. Subsequently, the compute entity CE1 detects a membership inconsistency (e.g., device conflict) because device2 has stored thereon the incorrect group name. The compute entity CE1, upon determining that device2 should no longer be a part of the group, and without involving the compute entity CE2, may then automatically resolve the inconsistency.

When each of the changes or resolutions has been made, the compute entity CE1 may communicate such to the compute entity CE2.

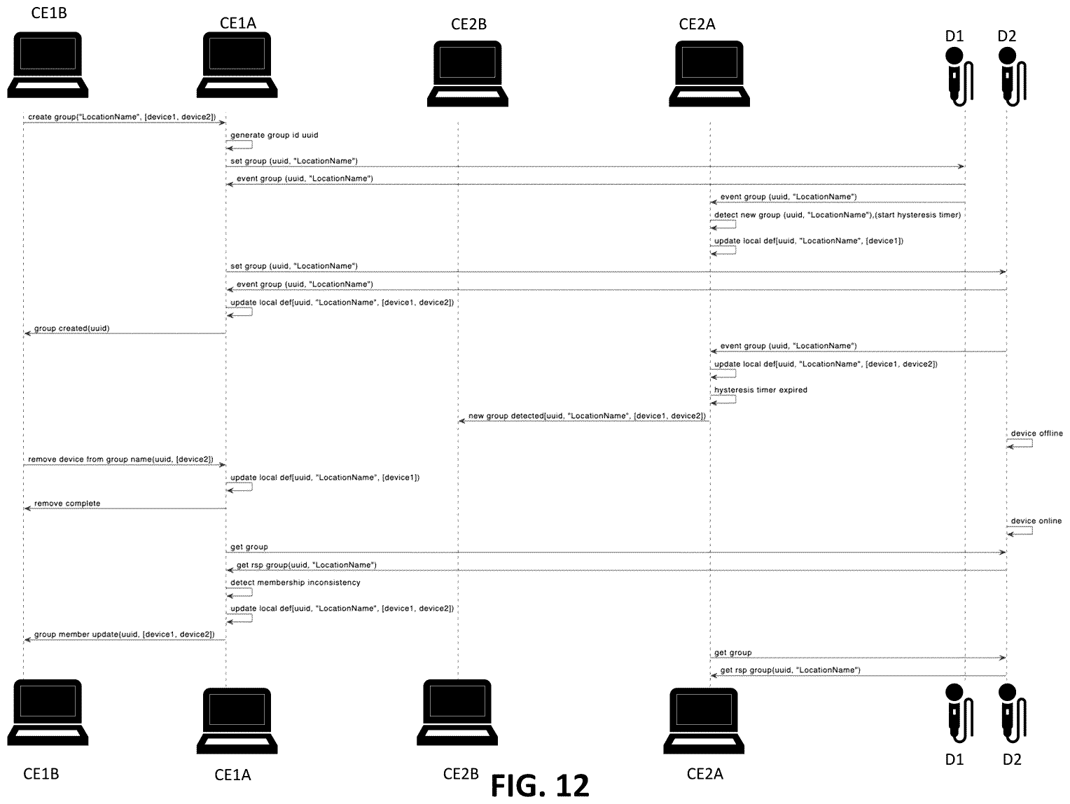

FIG. 12 depicts an operational example of resolution of device membership inconsistency, with multiple compute entities (CE1A, CE1B, CE2A, CE2B), in accordance with embodiments herein. In FIG. 12, a compute entity CE1B may request to another compute entity CE1A (e.g., which may be collocated with or separate from one another, in accordance with a controller apparatus such as apparatus 200) to create a group (e.g., a group configuration data structure). The compute entity CE1A may then be configured to generate a group UUID and group name and transmit the same to device D1 and device D2 (e.g., devices 102a-102e or 112a-112e). The compute entity CE1A may also be configured to receive an echo of the group UUID and group name from each of device D1 and device D2. The compute entity CE1A may then communicate the group UUID and group location to the compute entity CE1B.

Device D2 may go offline for some reason before the compute entity CE1B requests to remove device D2 from the group. In such an example, device D2 is not in receipt of the updated group when it comes back online. Subsequently, the compute entity CE1A detects a membership inconsistency (e.g., device conflict) because device D2 has stored thereon the incorrect group name. The compute entity CE1A, upon determining that device D2 should no longer be a part of the group, and without involving the compute entity CE1B, may then automatically resolve the inconsistency.

When each of the changes or resolutions has been made, the compute entity CE1A may communicate such to the compute entity CE1B. A compute entity CE2B and another compute entity CE2A (e.g., which may be collocated with or separate from one another, in accordance with a controller apparatus such as apparatus 200) may be updated based on receiving data from devices D1 and D2.

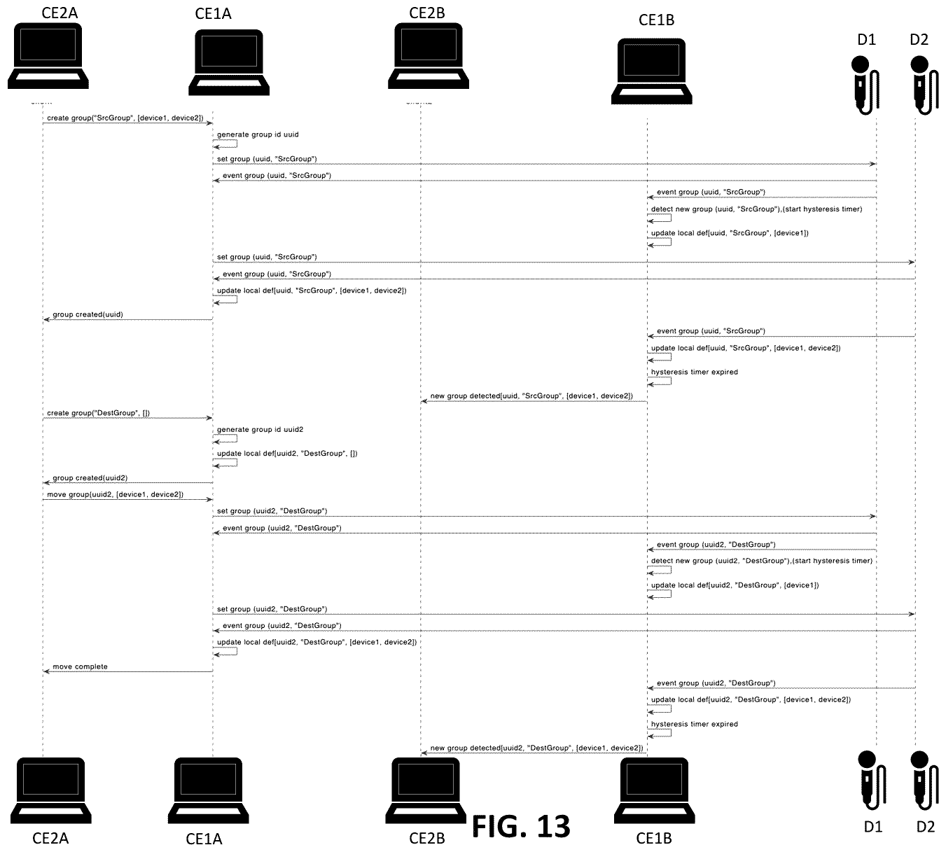

FIG. 13 depicts an operational example of a group move, with multiple compute entities (CE1A, CE1B, CE2A, CE2B), in accordance with embodiments herein. In FIG. 13, a compute entity CE1B may request to another compute entity CE1A (e.g., which may be collocated with or separate from one another, in accordance with a controller apparatus such as apparatus 200) to create a group (e.g., a group configuration data structure) associated with a first or source group. The compute entity CE1A may then be configured to generate a group UUID and group name and transmit the same to device D1 and device D2 (e.g., devices 102a-102e or 112a-112e). The compute entity CE1A may also be configured to receive an echo of the group UUID and group name from each of device D1 and device D2. The compute entity CE1A may then communicate the group UUID and group name to the compute entity CE1B.

Compute entity CE1B may subsequently request to the compute entity CE1A to create a group (e.g., a group configuration data structure) associated with a second or destination group. The compute entity CE1A may then be configured to generate a new group UUID and group name and transmit the same to device D1 and device D2 (e.g., devices 102a-102e or 112a-112c).

When each of the new groups has been made, the compute entity CE1A may communicate such to the compute entity CE1B. A compute entity CE2B and another compute entity CE2A (e.g., which may be collocated with or separate from one another, in accordance with a controller apparatus such as apparatus 200) may be updated based on receiving data from devices D1 and D2.

### Additional Implementation Details

Although example processing systems have been described in herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a device is described herein to receive data from another device, it will be appreciated that the data may be received directly from another device or may be received indirectly via one or more intermediary devices, such as, for example, one or more servers, relays, routers, network access points, base stations, hosts, and/or the like (sometimes referred to herein as a “network”). Similarly, where a device is described herein to send data to another device, it will be appreciated that the data may be sent directly to another device or may be sent indirectly via one or more intermediary devices, such as, for example, one or more servers, relays, routers, network access points, base stations, hosts, and/or the like.

The term “circuitry” should be understood broadly to include hardware and, in some embodiments, software for configuring the hardware. With respect to components of the apparatus, the term “circuitry” as used herein should therefore be understood to include particular hardware configured to perform the functions associated with the particular circuitry as described herein. For example, in some embodiments, “circuitry” may include processing circuitry, storage media, network interfaces, input/output devices, and the like.

The term “user” should be understood to refer to an individual, group of individuals, business, organization, and the like. The users referred to herein may access a group-based communication platform using client devices (as defined herein).

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept but are provided merely as a highlighting of some characteristics as described herein, without suggesting a particular order of importance or relevancy of such characteristics.

Clause 1. An apparatus comprising one or more processors and one or more memories storing instructions that are operable, when executed by the one or more processors, to cause the apparatus to generate a group configuration data structure associated with one or more devices, the group configuration data structure comprising a group configuration identifier and one or more device identifiers each associated with a device of the one or more devices, transmit, to each device of the one or more devices and based at least in part on the group configuration data structure, shared group configuration data comprising the group configuration identifier and the one or more device identifiers, receive, from one or more devices located within a network proximity, shared group configuration data, responsive to determining that a device conflict exists associated with the shared group configuration data, select as current shared group configuration data received shared group configuration data associated with a most recent update timestamp, and transmit the current shared group configuration data to each device located within the network proximity.

Clause 2. An apparatus according to Clause 1, wherein each device of the one or more devices is configured to store an update timestamp associated with a most recent creation or update of shared group configuration data.

Clause 3. An apparatus according to any of the foregoing Clauses, wherein determining that a device conflict exists comprises receiving first shared group configuration data from a first device of the one or more devices, receiving second shared group configuration data from a second device of the one or more devices, and determining one or more of a membership conflict exists when the first shared group configuration data comprises one or more device identifiers that do not match with those contained in the second shared group configuration data, or a common data conflict exists when the first shared group configuration data comprises a group UUID or a group name that does not match with those contained in the second shared group configuration data.

Clause 4. An apparatus according to any of the foregoing Clauses, wherein the group configuration data structure is mapped to a physical enclosure.

Clause 5. An apparatus according to any of the foregoing Clauses, wherein the group configuration data structure further comprises one or more of device coordinates associated with each device identifier, a physical enclosure identifier, physical dimensions associated with the physical enclosure, acoustic or other features associated with the physical enclosure, or metadata associated with the physical enclosure.

Clause 6. An apparatus according to any of the foregoing Clauses, wherein the physical enclosure is one or more of a conference room, a room, an auditorium, an audio playback zone, or a building.

Clause 7. An apparatus according to any of the foregoing Clauses, wherein the update timestamp is associated with one or more of a first generation of shared group configuration data or a subsequent update of shared group configuration data.

Clause 8. An apparatus according to any of the foregoing Clauses, wherein, prior to receiving the shared group configuration data, the one or more memories store instructions that are operable, when executed by the one or more processors, to further cause the apparatus to receive, from one or more devices located within a network proximity, a respective device type and device identifier, and request, from the one or more devices, the shared group configuration data.

Clause 9. An apparatus according to any of the foregoing Clauses, wherein the respective device identifier and device type is received from each device based at least in part on a multicast protocol or a unicast protocol.

Clause 10. An apparatus according to any of the foregoing Clauses, wherein the one or more memories store instructions that are operable, when executed by the one or more processors, to further cause the apparatus to generate a user interface configured to render display of at least a portion of the current shared group configuration data, and cause display of the user interface via a display device.

Clause 11. An apparatus according to any of the foregoing Clauses, wherein the one or more devices comprise an audio capture device, a microphone, a vision device, a video capture device, an infrared device, an ultrasound device, a radar device, a light detecting and ranging (LiDAR) device, a computing device, a mobile computing device, an audio output device, a video output device, an output device, or a combination thereof.

Clause 12. A system comprising one or more devices and a controller apparatus. The controller apparatus is configured to generate a group configuration data structure associated with one or more devices, the group configuration data structure comprising a group configuration identifier and one or more device identifiers each associated with the one or more devices, transmit, to each device of the one or more devices and based at least in part on the group configuration data structure, shared group configuration data comprising the group configuration identifier and the one or more device identifiers, receive, from one or more devices located within a network proximity, shared group configuration data, and responsive to determining that a device conflict exists associated with the shared group configuration data, select as current shared group configuration data r received shared group configuration data associated with a most recent update timestamp, and transmit the current shared group configuration data to each device located within the network proximity.

Clause 13. A non-transitory computer readable storage medium storing instructions that are operable, when executed by one or more processors of an apparatus, to cause the apparatus to generate a group configuration data structure associated with one or more devices, the group configuration data structure comprising a group configuration identifier and one or more device identifiers each associated with a device of the one or more devices; transmit, to each device of the one or more devices and based at least in part on the group configuration data structure, shared group configuration data comprising the group configuration identifier and the one or more device identifiers; receive, from one or more devices located within a network proximity, shared group configuration data; and responsive to determining that a device conflict exists associated with the shared group configuration data, select as current shared group configuration data received shared group configuration data associated with a most recent update timestamp; and transmit the current shared group configuration data to each device located within the network proximity.

Clause 14. A non-transitory computer readable storage medium according to the foregoing Clause, wherein each device of the one or more devices is configured to store an update timestamp associated with a most recent creation or update of shared group configuration data.

Clause 15. A non-transitory computer readable storage medium according to any of the foregoing Clauses, wherein determining that a device conflict exists comprises: receiving first shared group configuration data from a first device of the one or more devices; receiving second shared group configuration data from a second device of the one or more devices; and determining one or more of: a membership conflict exists when the first shared group configuration data comprises one or more device identifiers that do not match with those contained in the second shared group configuration data; or a common data conflict exists when the first shared group configuration data comprises a group UUID or a group name that does not match with those contained in the second shared group configuration data.

Clause 16. A non-transitory computer readable storage medium according to any of the foregoing Clauses wherein the group configuration data structure is mapped to a physical enclosure.

Clause 17. A non-transitory computer readable storage medium according to any of the foregoing Clauses, wherein the group configuration data structure further comprises one or more of device coordinates associated with each device identifier, a physical enclosure identifier, physical dimensions associated with the physical enclosure, acoustic or other features associated with the physical enclosure, or metadata associated with the physical enclosure.

Clause 18. A non-transitory computer readable storage medium according to any of the foregoing Clauses, wherein the physical enclosure is one or more of a conference room, a room, an auditorium, an audio playback zone, or a building.

Clause 19. A non-transitory computer readable storage medium according to any of the foregoing Clauses, wherein the update timestamp is associated with one or more of a first generation of shared group configuration data or a subsequent update of shared group configuration data.

Clause 20. A non-transitory computer readable storage medium according to any of the foregoing Clauses, wherein, prior to receiving the shared group configuration data, the instructions are operable, when executed by the one or more processors of the apparatus, to further cause the apparatus to: receive, from one or more devices located within a network proximity, a respective device type and respective device identifier; and request, from the one or more devices, the shared group configuration data.

Clause 21. A non-transitory computer readable storage medium according to any of the foregoing Clauses, wherein the respective device identifier and device type is received from each device based at least in part on a multicast protocol or a unicast protocol.

Clause 22. A non-transitory computer readable storage medium according to any of the foregoing Clauses, wherein the instructions are operable, when executed by the one or more processors of the apparatus, to further cause the apparatus to: generate a user interface configured to render display of at least a portion of the current shared group configuration data; and cause display of the user interface via a display device.

Clause 23. A non-transitory computer readable storage medium according to any of the foregoing Clauses, wherein the one or more devices comprise an audio capture device, a microphone, a vision device, a video capture device, an infrared device, an ultrasound device, a radar device, a light detecting and ranging (LiDAR) device, a computing device, a mobile computing device, an audio output device, a video output device, an output device, or a combination thereof.

Clause 24. A computer-implemented method, comprising: generating a group configuration data structure associated with one or more devices, the group configuration data structure comprising a group configuration identifier and one or more device identifiers each associated with a device of the one or more devices; transmitting, to each device of the one or more devices and based at least in part on the group configuration data structure, shared group configuration data comprising the group configuration identifier and the one or more device identifiers; receiving, from one or more devices located within a network proximity, shared group configuration data; and responsive to determining that a device conflict exists associated with the shared group configuration data, selecting as current shared group configuration data received shared group configuration data associated with a most recent update timestamp; and transmitting the current shared group configuration data to each device located within the network proximity.

Clause 25. A computer-implemented method according to the foregoing Clause, wherein each device of the one or more devices is configured to store an update timestamp associated with a most recent creation or update of shared group configuration data.

Clause 26. A computer-implemented method according to any of the foregoing Clauses, wherein determining that a device conflict exists comprises: receiving first shared group configuration data from a first device of the one or more devices; receiving second shared group configuration data from a second device of the one or more devices; and determining one or more of: a membership conflict exists when the first shared group configuration data comprises one or more device identifiers that do not match with those contained in the second shared group configuration data; or a common data conflict exists when the first shared group configuration data comprises a group UUID or a group name that does not match with those contained in the second shared group configuration data.

Clause 27. A computer-implemented method according to any of the foregoing Clauses, wherein the group configuration data structure is mapped to a physical enclosure.

Clause 28. A computer-implemented method according to any of the foregoing Clauses, wherein the group configuration data structure further comprises one or more of device coordinates associated with each device identifier, a physical enclosure identifier, physical dimensions associated with the physical enclosure, acoustic or other features associated with the physical enclosure, or metadata associated with the physical enclosure.

Clause 29. A computer-implemented method according to any of the foregoing Clauses, wherein the physical enclosure is one or more of a conference room, a room, an auditorium, an audio playback zone, or a building.

Clause 30. A computer-implemented method according to any of the foregoing Clauses, wherein the update timestamp is associated with one or more of a first generation of shared group configuration data or a subsequent update of shared group configuration data.

Clause 31. A computer-implemented method according to any of the foregoing Clauses, wherein, prior to receiving the shared group configuration data, the method further comprises receiving, from one or more devices located within a network proximity, a respective device type and respective device identifier; and requesting, from the one or more devices, the shared group configuration data.

Clause 32. A computer-implemented method according to any of the foregoing Clauses, wherein the respective device identifier and device type is received from each device based at least in part on a multicast protocol or a unicast protocol.

Clause 33. A computer-implemented method according to any of the foregoing Clauses, further comprising generating a user interface configured to render display of at least a portion of the current shared group configuration data; and causing display of the user interface via a display device.

Clause 34. A computer-implemented method according to any of the foregoing Clauses, wherein the one or more devices comprise an audio capture device, a microphone, a vision device, a video capture device, an infrared device, an ultrasound device, a radar device, a light detecting and ranging (LiDAR) device, a computing device, a mobile computing device, an audio output device, a video output device, an output device, or a combination thereof.

Clause 35. An apparatus comprising one or more processors and one or more memories storing instructions that are operable, when executed by the one or more processors, to cause the apparatus to receive, from one or more devices located within a network proximity, shared group configuration data, and, responsive to determining that a device conflict exists associated with the shared group configuration data, select as current shared group configuration data received shared group configuration data associated with a most recent update timestamp, and transmit the current shared group configuration data to each device located within the network proximity.

Clause 36. A non-transitory computer readable storage medium storing instructions that are operable, when executed by one or more processors of an apparatus, to cause the apparatus to receive, from one or more devices located within a network proximity, shared group configuration data, and, responsive to determining that a device conflict exists associated with the shared group configuration data, select as current shared group configuration data received shared group configuration data associated with a most recent update timestamp, and transmit the current shared group configuration data to each device located within the network proximity.

Clause 37. A computer-implemented method, comprising receiving, from one or more devices located within a network proximity, shared group configuration data, and, responsive to determining that a device conflict exists associated with the shared group configuration data, selecting as current shared group configuration data received shared group configuration data associated with a most recent update timestamp, and transmitting the current shared group configuration data to each device located within the network proximity

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising one or more processors and one or more memories storing instructions that are operable, when executed by the one or more processors, to cause the apparatus to:
generate a group configuration data structure associated with one or more devices, the group configuration data structure comprising a group configuration identifier and one or more device identifiers each associated with a device of the one or more devices;
transmit, to each device of the one or more devices and based at least in part on the group configuration data structure, shared group configuration data comprising the group configuration identifier and the one or more device identifiers;
receive, from one or more devices located within a network proximity, shared group configuration data; and
responsive to determining that a device conflict exists associated with the shared group configuration data,
select as current shared group configuration data received shared group configuration data associated with a most recent update timestamp; and
transmit the current shared group configuration data to each device located within the network proximity.

2. The apparatus of claim 1, wherein each device of the one or more devices is configured to store an update timestamp associated with a most recent creation or update of shared group configuration data.

3. The apparatus of claim 2, wherein determining that a device conflict exists comprises:
receiving first shared group configuration data from a first device of the one or more devices;
receiving second shared group configuration data from a second device of the one or more devices; and
determining one or more of:
a membership conflict exists when the first shared group configuration data comprises one or more device identifiers that do not match with those contained in the second shared group configuration data; or
a common data conflict exists when the first shared group configuration data comprises a group UUID or a group name that does not match with those contained in the second shared group configuration data.

4. The apparatus of claim 1, wherein the group configuration data structure is mapped to a physical enclosure.

5. The apparatus of claim 4, wherein the group configuration data structure further comprises one or more of device coordinates associated with each device identifier, a physical enclosure identifier, physical dimensions associated with the physical enclosure, acoustic or other features associated with the physical enclosure, or metadata associated with the physical enclosure.

6. The apparatus of claim 4, wherein the physical enclosure is one or more of a conference room, a room, an auditorium, an audio playback zone, or a building.

7. The apparatus of claim 1, wherein the update timestamp is associated with one or more of a first generation of shared group configuration data or a subsequent update of shared group configuration data.

8. The apparatus of claim 1, wherein, prior to receiving the shared group configuration data, the one or more memories store instructions that are operable, when executed by the one or more processors, to further cause the apparatus to:
receive, from one or more devices located within a network proximity, a respective device type and respective device identifier; and
request, from the one or more devices, the shared group configuration data.

9. The apparatus of claim 8, wherein the respective device identifier and device type is received from each device based at least in part on a multicast protocol or a unicast protocol.

10. The apparatus of claim 1, wherein the one or more memories store instructions that are operable, when executed by the one or more processors, to further cause the apparatus to:
generate a user interface configured to render display of at least a portion of the current shared group configuration data; and
cause display of the user interface via a display device.

11. The apparatus of claim 1, wherein the one or more devices comprise an audio capture device, a microphone, a vision device, a video capture device, an infrared device, an ultrasound device, a radar device, a light detecting and ranging (LiDAR) device, a computing device, a mobile computing device, an audio output device, a video output device, an output device, or a combination thereof.

12. (canceled)

13. A non-transitory computer readable storage medium storing instructions that are operable, when executed by one or more processors of an apparatus, to cause the apparatus to:
generate a group configuration data structure associated with one or more devices, the group configuration data structure comprising a group configuration identifier and one or more device identifiers each associated with a device of the one or more devices;
transmit, to each device of the one or more devices and based at least in part on the group configuration data structure, shared group configuration data comprising the group configuration identifier and the one or more device identifiers;
receive, from one or more devices located within a network proximity, shared group configuration data; and
responsive to determining that a device conflict exists associated with the shared group configuration data,
select as current shared group configuration data received shared group configuration data associated with a most recent update timestamp; and
transmit the current shared group configuration data to each device located within the network proximity.

14. The non-transitory computer readable storage medium of claim 13, wherein each device of the one or more devices is configured to store an update timestamp associated with a most recent creation or update of shared group configuration data.

15. The non-transitory computer readable storage medium of claim 14, wherein determining that a device conflict exists comprises:
receiving first shared group configuration data from a first device of the one or more devices;
receiving second shared group configuration data from a second device of the one or more devices; and
determining one or more of:
a membership conflict exists when the first shared group configuration data comprises one or more device identifiers that do not match with those contained in the second shared group configuration data; or
a common data conflict exists when the first shared group configuration data comprises a group UUID or a group name that does not match with those contained in the second shared group configuration data.

16. The non-transitory computer readable storage medium of claim 13, wherein the group configuration data structure is mapped to a physical enclosure.

17. The non-transitory computer readable storage medium of claim 16, wherein the group configuration data structure further comprises one or more of device coordinates associated with each device identifier, a physical enclosure identifier, physical dimensions associated with the physical enclosure, acoustic or other features associated with the physical enclosure, or metadata associated with the physical enclosure.

18. The non-transitory computer readable storage medium of claim 17, wherein the physical enclosure is one or more of a conference room, a room, an auditorium, an audio playback zone, or a building.

19. The non-transitory computer readable storage medium of claim 13, wherein the update timestamp is associated with one or more of a first generation of shared group configuration data or a subsequent update of shared group configuration data.

20. The non-transitory computer readable storage medium of claim 13, wherein, prior to receiving the shared group configuration data, the instructions are operable, when executed by the one or more processors of the apparatus, to further cause the apparatus to:
receive, from one or more devices located within a network proximity, a respective device type and respective device identifier; and
request, from the one or more devices, the shared group configuration data.

21-34. (canceled)

35. An apparatus comprising one or more processors and one or more memories storing instructions that are operable, when executed by the one or more processors, to cause the apparatus to:
receive, from one or more devices located within a network proximity, shared group configuration data; and
responsive to determining that a device conflict exists associated with the shared group configuration data,
select as current shared group configuration data received shared group configuration data associated with a most recent update timestamp; and
transmit the current shared group configuration data to each device located within the network proximity.

36-37. (canceled)
